(19) United States
(12) Patent Application Publication
(10) Pub. No.: US 2013/0282460 A1
(43) Pub. Date: Oct. 24, 2013

(54) MANAGEMENT OF MULTIPLE ELECTRONIC DEVICES IN A TRANSACTION SESSION

(71) Applicants: Susan W. Brosnan, Raleigh, NC (US); Dean F. Herring, Youngsville, NC (US); David T. Rogers, Wake Forest, NC (US)

(72) Inventors: Susan W. Brosnan, Raleigh, NC (US); Dean F. Herring, Youngsville, NC (US); David T. Rogers, Wake Forest, NC (US)

(73) Assignee: INTERNATIONAL BUSINESS MACHINES CORPORATION, Armonk, NY (US)

(21) Appl. No.: 13/455,110

(22) Filed: Apr. 24, 2012

(51) Int. Cl. G06Q 20/40; G06Q 30/02; G06Q 20/20

(52) U.S. Cl. 705/14.23; 705/44; 705/16

(57) ABSTRACT

In accordance with one or more embodiments of the present invention, methods and systems disclosed herein provide for management of multiple electronic devices in a transaction session. An example method includes associating a user identifier of a first shopper with a transaction session. The method may also include receiving, from a second shopper, a request to join the transaction session. Further, the method may include processing the transaction session based on the request.

### BACKGROUND

1. Field of the Invention

The present invention relates to transactions, and more specifically, to management of multiple electronic devices in a transaction session.

2. Description of Related Art

In retail environments, such as grocery stores and other “brick and mortar” stores, shoppers typically gather products and later go to a transaction, point-of-sale (POS), or checkout terminal to purchase the products. A transaction terminal manages the selling process by a salesperson accessible interface. In another example, the transaction terminal may be a self-checkout terminal that provides a mechanism for shoppers to pay for purchases without direct input to the process by the retailer's staff. Such transaction terminals typically include a barcode reader capable of reading barcodes attached to products for obtaining an identifier for the respective product. The transaction terminal may then total prices of the products and conduct a purchase transaction for purchase of the products.

Oftentimes, more than one shopper will gather products in a retail environment and later meet at a transaction terminal to purchase all of the gathered products in a single purchase transaction. Such shoppers may shop independently of each other in the retail environment to hasten the shopping experience. One reason that shoppers may gather products for purchase in a single purchase transaction includes obtaining a discount based on a price total for the purchase transaction or a total number of products purchased. Accordingly, there is a need for improved technology for enabling shoppers to efficiently manage collective shopping efforts in a retail environment.

### BRIEF SUMMARY

In accordance with one or more embodiments of the present invention, methods and systems disclosed herein provide for management of multiple electronic devices in a transaction session. An example method includes associating a user identifier of a first shopper with a transaction session. The method may also include receiving, from a second shopper, a request to join the transaction session. Further, the method may include processing the transaction session based on the request.

In accordance with embodiments of the present invention, an example method may include presenting transaction session information of a first shopper. The method may also include receiving user input to join the transaction session. Further, the method may include communicating to an electronic device a request to join the transaction session in response to receiving the user input.

In accordance with embodiments of the present invention, an example method may include managing a transaction session of a first shopper. The method may also include receiving a request for allowing a second shopper to join the transaction session. Further, the method may include receiving user input in response to the request. The method may also include communicating the user input to an electronic device for responding to the request.

### BRIEF DESCRIPTION OF THE SEVERAL VIEWS OF THE DRAWINGS

FIG. 1 is a block diagram of a purchase transaction system according to embodiments of the present invention;

FIG. 2 is a flowchart of a method for receiving and processing a request to join a transaction session in accordance with embodiments of the present invention;

FIG. 3 is a flowchart of a method for generating a request to join a transaction session and for communicating the request to a server in accordance with embodiments of the present invention; and

FIG. 4 is a flowchart of a method for receiving a request to join a transaction session and for responding to the request in accordance with embodiments of the present invention.

### DETAILED DESCRIPTION

Exemplary systems and methods for managing multiple electronic devices in a transaction session in accordance with embodiments of the present invention are disclosed herein. Particularly, disclosed herein is a purchase transaction system configured to assist shoppers in joining together their shopping efforts in a single purchase transaction. In an example, the shoppers may each operate a mobile electronic device, such as a smart phone, configured with a transaction manager. Each shopper may carry a mobile electronic device as he or she browses products in a retail environment and gathers one or more products for purchase. Further, each shopper may use his or her device for acquiring identifiers from collected products. Example product identifiers may include, but is not limited to, electronic product code (EPC) information from the product or radio frequency identification (RFID) information from the product. For example, the mobile electronic device may be controlled by the shopper to capture an electronic product code (EPC) (e.g., uniform product code (UPC) or quick response (QR) code) printed on a product label or packaging. Further, one of the shoppers may control his or her device to initiate a transaction session with a mobile server within the retail environment. As described in further detail herein, the transaction session may facilitate purchase of products when the shopper pays for the products at a transaction terminal. Another shopper may also acquire product identifiers from products in the retail environment, and use his or her device to join the transaction session. Product identifiers acquired by the shoppers may be associated with the transaction session such that a single payer, who may be one of the shoppers, can pay for the products in a single purchase transaction at a transaction terminal or via any other suitable technique.

As referred to herein, the term “electronic device” should be broadly construed. It can include any type of device capable of acquiring a product identifier from a product and capable of interacting with a user. For example, the electronic device may be a smart phone including a camera configured to capture one or more images of a product. In another example, the electronic device may include components configured to read, scan, or otherwise determine an identifier (e.g., a UPC on a product) of a product. The electronic device may be a mobile electronic device such as, for example, but not limited to, a smart phone, a cell phone, a pager, a personal digital assistant (PDA, e.g., with GPRS NIC), a mobile computer with a smart phone client, or the like. An electronic device can also include any type of conventional computer, for example, a laptop computer or a tablet computer. A typical mobile electronic device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable electronic device, such as a computer.

As referred to herein, the term “user interface” is generally a system by which users interact with an electronic device. A user interface can include an input for allowing users to manipulate an electronic device, and can include an output for allowing the electronic device to present information and/or data, indicate the effects of the user's manipulation, etc. An example of a user interface on an electronic device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of an electronic device for interaction. The display object can be displayed on a display screen of an electronic device and can be selected by and interacted with by a user using the user interface. In an example, the display of the electronic device can be a touch screen, which can display the display icon. The user can depress the area of the display screen where the display icon is displayed for selecting the display icon. In another example, the user can use any other suitable user interface of an electronic device, such as a keypad, to select the display icon or display object. For example, the user can use a track ball or arrow keys for moving a cursor to highlight and select the display object.

As referred to herein, the term “identifier” may be any type of identifier that identifies a product or a user. A product identifier may be acquired from a product. In an example, a product identifier may include EPC information that provides a unique identity for each type of product. In this example, the EPC information may be obtained by scanning coded information from a product including, but not limited to, information encoded in a UPC or RFID tag affixed to the product or packaging of the product. An electronic device in accordance with embodiments of the present invention may acquire a product identifier for use in conducting a purchase transaction. A user identifier may uniquely identify a user (e.g., a shopper). For example, a user identifier may be a login name or a combination of characters (e.g., letters and/or numeric characters) that uniquely identify a user.

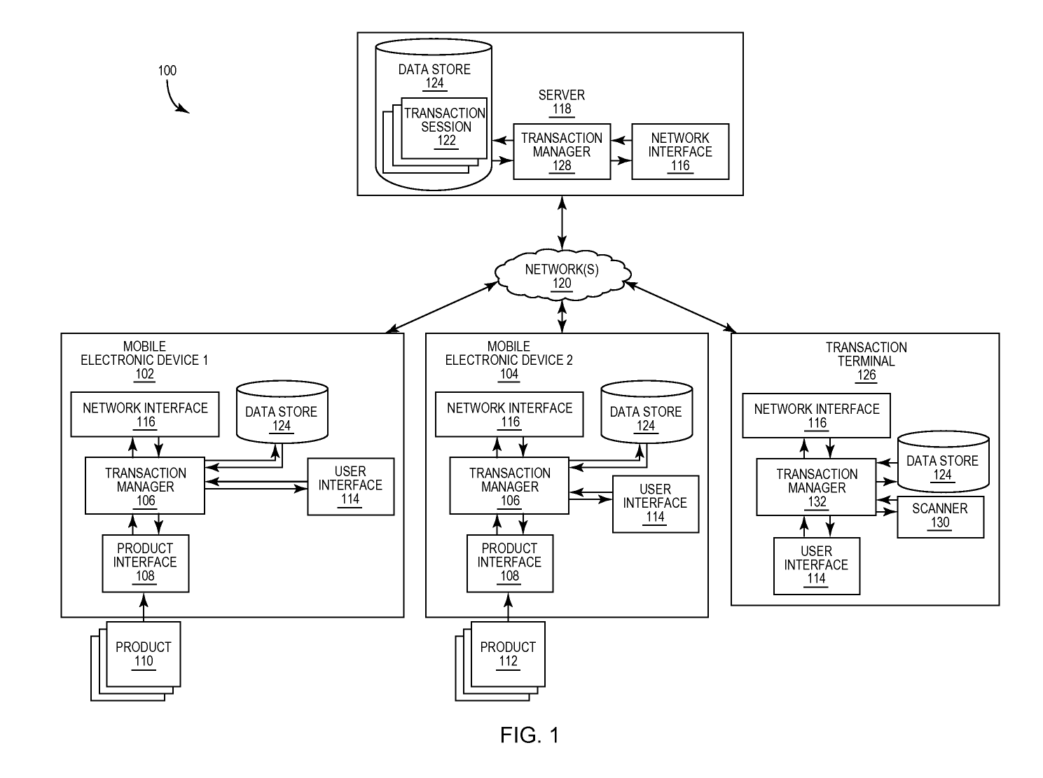

The presently disclosed invention is now described in more detail. Forexample, FIG. 1 illustrates a block diagram of a purchase transaction system 100 according to embodiments of the present invention. The system 100 may be implemented in whole or in part in any suitable environment for conducting purchase transactions. For example, the system 100 may be implemented in a retail store having a variety of products and one or more transaction terminals. Referring to FIG. 1, the system 100 may include mobile electronic device 1 (designated 102) and mobile electronic device 2 (designated 104) that each have a transaction manager 106 configured to acquire a product identifier from one or more products, to manage a transaction session, and to conduct a purchase transaction. More particularly, for example, electronic devices 102 and 104 may each include a product interface 108 configured to acquire an identifier from a product. For example, electronic device 102 may acquire product identifiers from products 110 in one set of products. In another example, electronic device 104 may acquire product identifiers from products 112 in another set of products. For example, product data may include, but is not limited to, electronic product code (EPC) information from the product, and radio frequency identification (RFID) information from the product. In an example, the product interface 108 may be a camera and/or scanner configured to acquire product data from products.

According to embodiments of the present invention, a user of the one of the electronic devices 102 and 104 may use an application (often referred to as an “app”) residing on the electronic device to interact with the transaction manager 106 via a user interface 114 for implementing the functions according to embodiments of the present invention. The application may reside on the electronic device and may be part of the transaction manager 106. The user may, for example, input commands into the user interface 114 for controlling the product interface 108 to acquire an identifier of the product 108 and/or other products within a retail environment. The user may also, for example, position the electronic device 102 relative to the product such that the product interface 108 can acquire the product identifier. Further, for example and as disclosed in more detail herein, the user may input commands into the user interface 114 for negotiating purchase of the product with a retailer. The application may have been downloaded from a web server and installed on the electronic device in any suitable manner. The application may be downloaded to another machine and then transferred to the electronic device. In an example, the application can enable the electronic device with one or more of the features according to embodiments of the present invention.

The transaction manager 106 may control the product interface 108 to acquire the product identifier from the product. For example, a user may position the electronic device relative to the product such that a camera of the electronic device can capture an image of a portion or the entirety of the product. The captured image may include, for example, a label identifying the product and/or features of the product, such as a shape and/or color, that can be analyzed to generate an identifier for the product.

The transaction manager 106 may also manage a transaction session for a shopper in accordance with embodiments of the present invention. For example, a user of the mobile electronic device 102 may interact with the user interface 114 to open a transaction application residing on the device 102. Further, the user may interact with the user interface 114 to initiate a transaction session within a retail environment. In response to initiation of the transaction session, the transaction manager 106 may control a network interface 116 of the electronic device 102 to locate a nearby mobile server 118 via one or more communications networks 120. Subsequently, a communication link between the server 118 and the device 102 may be established. Data of a transaction session 122 may be stored within a data store 124. The transaction manager 106 of the device 102 may communicate customer card information, login credentials, and/or other identification information to the server 118 via the communications network(s) 120. The communications networks 116 may include communication technology such as near field communication (NFC) technology, radio frequency identification (RFID) technology, and BLUETOOTH® technology. The transaction manager 128 at the server 118 may be used to initialize the transaction session and store data related thereto transaction session data 122 in the data store 124. The device 102 may acquire identifiers for one or more products 110, and may communicate the identifiers to the server 118 for association with the transaction session. Subsequently, the shopper may pay for the identified products at a transaction terminal 126 via any suitable technique.

A user of the device 104 may join the transaction session initiated by the user of the device 102. Particularly, the user of the device 104 may interact with the user interface 114 to generate a request to join the transaction session, and to communicate the request to the server 118. The transaction manager 106 of the device 104 may communicate customer card information, login credentials, and/or other identification information to the server 118 via the communications network(s) 120 as a request to join the transaction session with the user of the device 102. A transaction manager 128 of the server 118 may receive the request and may accept or decline the request. If the request is accepted, the device 104 may add its acquired product identifiers to the transaction session for subsequent purchase in a single purchase transaction along with the products identified with the device 102. If the request is denied, the device may be prevented from joining the transaction session.

In an example of acquiring a product identifier from a product 110, the product interface 108 may be configured to read a machine-readable image representing data from the product 110. For example, the product interface 108 may be positioned over a barcode (e.g., a UPC, QR code, or any other machine-readable image) on the product 110. The read product data may include information for identifying the product 110 or for providing other information about the product 110.

Communication between the server 118 and one of the electronic devices 102 and 104 may be implemented via any suitable technique and any suitable communications network. For example, the electronic device 102 and the server 118 may interface with one another to communicate or share data over a suitable communications network, such as, but not limited to, the Internet, a local area network (LAN), or a wireless network, such as a cellular network. As an example, the electronic device 102 and the server 118 may communicate with one another via a WIFI® connection or via a web-based application.

The transaction managers 106 and 128 may each be implemented by hardware, software, firmware, of combinations thereof. For example, software residing on a data store may include instructions implemented by a processor for carrying out functions of a transaction manager disclosed herein.

The transaction terminal 126 may receive information from the server 118 about the transaction session of the devices 102 and 104. Particularly, the transaction terminal 126 may receive product identifiers acquired by the devices 102 and 104 for use in conducting a purchase transaction. Further, the transaction terminal 126 may include a scanner 130 configured to read a machine-readable image representing data from a product. The scanner 130 may be a handheld device that can be passed over a barcode (e.g., a UPC or any other machine-readable image) on one of the products or may be built into a counter or platform whereby products are passed over the scanner 130. Further, the scanner 130 may read data from products and transmit the data to the transaction manager 132 residing on the transaction terminal 126 via, for example, a wireless or wireline connection. In an example, the machine-readable image on the product may represent identification of the product. Identification of products may alternatively be provided to the transaction terminal 126 by, for example, a user entering an identifier, such as a number, representing the product. The product identifiers may be stored in a suitable memory, such as the data store 124 of the transaction terminal 126. The product identifiers obtained by scanning or otherwise at the transaction terminal 126 may be combined with the product identifiers acquired by the devices 102 and 104 for purchase in a single purchase transaction.

The user interface 114 of the transaction terminal 126 may be used by the user of one of the electronic devices 102 and 104. The user interface 114 may include a keyboard device for enabling the user to enter identification information for associating the user with the transaction session. For example, the user may enter his or her customer card information, login credentials, and/or other identification information. Further, the customer may input account and payment information for payment of the product identifiers associated with the transaction session. The user interface 114 may include a scanning device for reading a customer's financial card (e.g., credit card or debit card) including account number. The keypad device may enable a shopper to enter a personal identification number (PIN) if using a debit card. The user interface 114 may include a display for displaying transaction information to the customer. For example, the user interface 114 may be a touchscreen display for displaying text and graphics and for receiving user input. The user interface 114 may be communicatively coupled to the transaction terminal 126 via wireless or wireline elements.

The transaction terminal 126 may also include a product detection device, such as, but not limited to, a scale, sensor, or other instrument that captures information relating to products. In an example, the product detection device may detect the presence of a product at a bagging area. Further, for example, the product detection device may capture weight, dimension, color, and/or other measurements of products. The transaction terminal 126 may use this information for identifying the product.

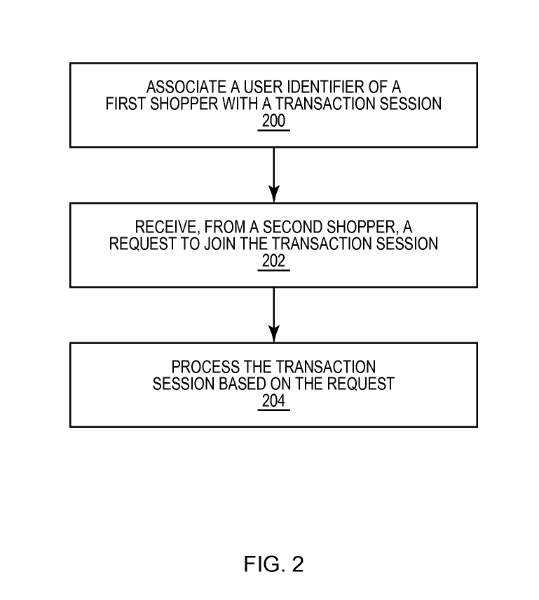

In accordance with embodiments of the present invention, the transaction manager 128 of the server 118 is configured to manage multiple electronic devices in a transaction session. In an example, FIG. 2 illustrates a flowchart of a method for receiving and processing a request to join a transaction session in accordance with embodiments of the present invention. The method of FIG. 2 is described as being implemented by the server 118 shown in FIG. 1, although the method may be implemented by any suitable electronic device. The method may be implemented by hardware, software, and/or firmware of the server 118 and/or another electronic device.

Referring to FIG. 2, the method includes associating 200 a user identifier of a first shopper with a transaction session. For example, the user of the device 102 shown in FIG. 1 may interact with the user interface 114 of the device 102 to request initiation of a transaction session within a retail environment where the server 118 resides. The user may enter identification information, such as customer card information or login credentials. Alternatively, customer card information may be entered by scanning a customer card issued to the shopper by the retailer, or by capturing an image of the card. As an example, the customer card information may include a user identifier of the user (or shopper). The transaction manager 106 of the device 102 may process the request and wirelessly communicate the request to the server 118 via the network 120. The network interface 116 of the server 118 may receive the request and identification information. Subsequently, the transaction manager 128 of the server 118 may initialize the transaction session based on the request.

In an example of processing a transaction session based on a request, the transaction manager 128 of the server 118 may receive customer card information including the user identifier of a shopper using the device 102. The transaction manager 128 of the server 118 may compare the user identifier to data stored in the data store 124 or another memory to verify whether the shopper is registered as a customer. In response to verifying that the shopper is registered as a customer, the transaction manager 128 of the server 118 may initialize the requested transaction session and control the network interface 116 to report initialization of the transaction session to the device 102. In response to failing to verify that the shopper is registered as a customer, the transaction manager 128 of the server 118 may deny the request and control the network interface 116 to report the request denial to the device 102.

In another example of processing a transaction session based on a request, the transaction manager 128 of the server 118 may receive a user identifier of the shopper and a password. The transaction manager 128 of the server 118 may compare the user identifier and password to data stored in the data store 124 or another memory to verify whether the shopper is registered as a customer. In response to verifying that the shopper is registered as a customer, the transaction manager 128 of the server 118 may initialize the requested transaction session and control the network interface 116 to report initialization of the transaction session to the device 102. In response to failing to verify that the shopper is registered as a customer, the transaction manager 128 of the server 118 may deny the request and control the network interface 116 to report the request denial to the device 102.

The method of FIG. 2 includes receiving 202, from a second shopper, a request to join the transaction session. For example, the device 104 may receive notification from the server 118 via the network 120 of current transaction sessions, such as the transaction session 122 associated with the device 102. In response to receipt of the notification, the transaction manager 106 of the device 104 may control the user interface 114 to present the notice to the shopper. The notice may include identification about the transaction session, such as an identifier of other users associated with the transaction session, product identifiers associated with the transaction session, and the like. The user interface 114 of the device 104 may receive user input for selecting the transaction session and for sending a request to join the selected transaction session. The transaction manager 106 of the device 104 may receive the user input and control the network interface 116 to communicate the request to the server 118. The request may include identification information of the shopper using the device 104. For example, the request may include customer card information or login credentials, such as a user identifier of the shopper and a password.

The method of FIG. 2 includes processing 204 the transaction based on the request. For example, the transaction manager 128 of the server 118 may receive customer card information including a user identifier of the shopper using the device 104. In response to receipt of the information, the transaction manager 128 of the server 118 may verify the user identifier of the shopper. For example, the transaction manager 128 of the server 118 may compare the user identifier to data stored in the data store 124 to verify whether the shopper is registered as a customer. Further, the transaction manager 128 of the server 118 may verify whether the shopper is associated with the shopper using the device 102 such that the shoppers can be joined in the transaction session. In response to verifying that the shopper is registered as a customer and can join the transaction session, the transaction manager 128 of the server 118 may join the shopper using the device 104 with the transaction session and control the network interface 116 to report the joining to the device 104. In response to failing to verify that the shopper is registered as a customer or that the shopper can join the transaction session, the transaction manager 128 of the server 118 may deny the request and control the network interface 116 to report the request denial to the device 104. Alternatively for example, the server 118 may be provided with a user identifier and password for use in verifying whether the shopper is registered as a customer and can be joined in the transaction session.

Subsequent to joining shoppers in a transaction session, one of the shoppers may pay for products gathered by the shoppers in a single purchase transaction. For example, the shoppers may use their mobile electronic devices to acquire products identifiers of products they are gathering for purchase. The shoppers may then take the products to a transaction terminal, such as the transaction terminal 126, for conducting a purchase transaction. At the transaction terminal, the paying shopper may present identification information, such as customer card information or user identifier/password, for associating the shopper with the transaction session. The transaction manager 132 of the transaction terminal 126 may then verify the identification information and determine whether a transaction session is associated with the identification information. In response to determining the transaction session associated with the identification information, product identifiers associated with the transaction session may be presented via the user interface 114 of the transaction terminal 126. Further, the sale prices of the products may be totaled and presented via the user interface 114 of the transaction terminal 126. Subsequently, the paying shopper may pay for the products at the transaction terminal 126 using any suitable purchase transaction technique.

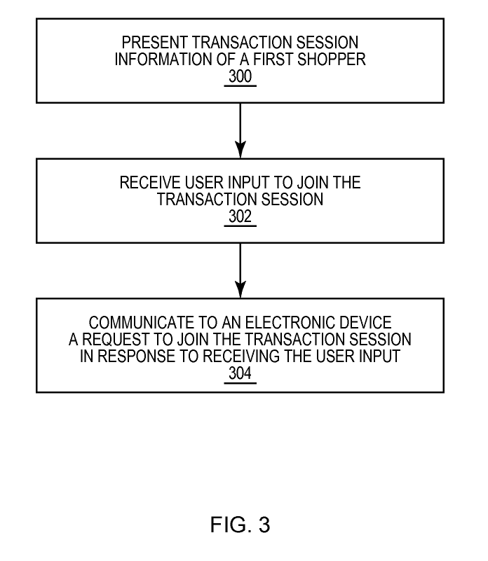

In accordance with embodiments of the present invention, a shopper using a mobile electronic device may view transaction session information of another shopper and request to join the transaction session. In an example, FIG. 3 illustrates a flowchart of a method for generating a request to join a transaction session and for communicating the request to a server in accordance with embodiments of the present invention. The method of FIG. 3 is described as being implemented by the system 100 shown in FIG. 1, although the method may be implemented by any suitable system. The method may be implemented by hardware, software, and/or firmware of the mobile electronic device 104.

The method of FIG. 3 includes presenting 300 transaction session information of a first shopper. For example, the user of the device 104 may interact with the user interface 114 to request presentation of transaction session information from the server 118. In response to the interaction, the transaction manager 106 of the device 104 may generate a request for transaction session information and may control the network interface 116 to communicate the request to the server 118 via the network 120. The transaction manager 128 of the server 118 may retrieve information about one or more transaction sessions 122 from the data store 124 to communicate to the device 104. The network interface 116 of the device 104 may receive the transaction session information from the network 120. The transaction manager 106 of the device 104 may subsequently present (e.g., display) the information via the user interface 114. The information presented to the user of the device 104 may include, for example, an identifier of a user associated with the transaction session 122 and product identifiers associated with the transaction session 122.

The method of FIG. 3 includes receiving 302 user input to join the transaction session. For example, the user interface 114 of the device 104 may receive user input for selecting the transaction session and for sending a request to join the selected transaction session 122. The transaction manager 106 of the device 104 may receive the user input for the request. The request may include identification information of the shopper using the device 104. For example, the request may include customer card information or login credentials, such as a user identifier of the shopper and a password. The identification information may be stored on the device 104 in the data store 124.

The method of FIG. 3 includes communicating 304 to an electronic device a request to join the transaction session in response to receiving the user input. For example, the transaction manager 106 of the device 104 may control the network interface 116 to communicate the request to the server 118. The server 118 may verify that the request should be granted or deny the request and notify the device 104 of the verification or denial.

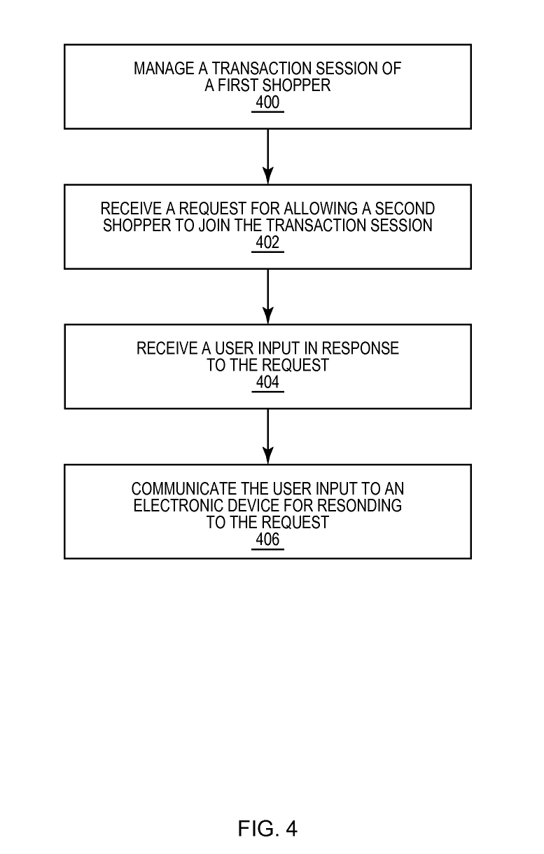

In accordance with embodiments of the present invention, a mobile electronic device may enable a shopper to view a request to join a transaction session and to accept or deny the request. In an example, FIG. 4 illustrates a flowchart of a method for receiving a request to join a transaction session and for responding to the request in accordance with embodiments of the present invention. The method of FIG. 4 is described as being implemented by the system 100 shown in FIG. 1, although the method may be implemented by any suitable system. The method may be implemented by hardware, software, and/or firmware of the mobile electronic device 102.

The method of FIG. 4 includes managing 400 a transaction session of a first shopper. For example, the device 104 may interact with the server 118 for establishing a transaction session as described in examples provided herein. Further, the device 104 may be operated to acquire product identifiers and associate the identifiers with the transaction session in accordance with examples provided herein.

The method of FIG. 4 includes receiving 402 a request for allowing a second shopper to join the transaction request. For example, the device 104 may communicate a request to join the transaction session to the server 118. In response to receipt of the request, the transaction manager 128 of the server 118 may communicate the request to the device 102.

The method of FIG. 4 includes receiving 404 user input in response to the request. For example, the network interface 114 of the device 102 may receive the request and control the user interface 114 to present the request to the user. For example, the transaction manager 106 of the device 102 may control the user interface 114 to display the request. The request may include identification of the user who sent the request. Further, the transaction manager 106 of the device 102 may control the user interface 114 to present to the user an option to accept or deny the request. Subsequently, the user interface 114 may receive the user's selection to either accept or deny the request.

The method of FIG. 4 includes communicating 406 the user input to an electronic device for responding to the request. For example, the transaction manager 106 of the device 102 may generate a message including the user's selection to accept or deny the request, and send the message to the server 118. In response to receipt of a message including acceptance of the request, the transaction manager 128 of the server 118 may join the device 104 with the transaction session, and may notify the device 104 of the acceptance in accordance with examples provided herein. In response to receipt of a message including denial of the request, the transaction manager 128 of the server 118 may prevent the device 104 from joining the transaction session, and may notify the device 104 of the denial in accordance with examples provided herein.

A purchase transaction may be conducted between the retailer and the shopper using the electronic device 102 and the transaction terminal 126. Initially at the terminal 126, the shopper may interact with the transaction terminal 126 for identifying the shopper. For example, the shopper may be identified based on scanning a financial card of the shopper. In another example, the shopper may provide other identification information, such customer card information, for identifying the shopper. Identification of the shopper may be used for accessing prices of products associated with the shopper's transaction session. Product price and transaction session information may be obtained from the server 118. For example, the server 118 may access the transaction session 122 for product identifiers and communicate prices of the products to the transaction terminal via the network 120. The transaction terminal 124 may subsequently use the product prices for conducting a transaction for purchase of the products associated with the transaction session.

In another example, a purchase transaction may be implemented without the need of a transaction terminal. For example, the sale may be finalized via a web-based transaction by use of a mobile device.

In accordance with embodiments of the present invention, a server and multiple mobile electronic devices may manage formation of a transaction session for securely identifying shoppers for inclusion in the transaction session. In an example, each device may communicate to a server a request along with identifiers of other devices or shoppers for inclusion in the transaction session. The server may manage formation of the transaction session or addition of the requesting device to the transaction session. If a transaction session has already been initiated, the server may add the requesting device to the transaction session. If a transaction session has not yet been initiated, the server may initiate the transaction session.

In accordance with embodiments of the present invention, a transaction log for each transaction session may be maintained by a server. Each log may include identification of each shopper associated with the transaction session and product identifiers acquired by each shopper. The log may be updated each time a product identifier is acquired or periodically. In this way, the log may be updated in real time. One or more of the devices associated with the transaction session may access data associated with the transaction session for presentation to the shopper.

In accordance with embodiments of the present invention, transaction data for each shopper may be maintained separately for each shopper. Each shopper may interact with his or her device to indicate that his or her shopping is complete. Once all shoppers associated with a transaction session have indicated that shopping is complete, the transactions may be combined into a single transaction session. For example, all product identifiers acquired by the shoppers may be combined into the single transaction session. Subsequently, the prices may be totaled, tax calculated, and one of the shoppers may conduct a purchase transaction to pay for all of the products. In an example, this shopper may manage the products to be purchased, such as removing one or more of the products or selecting a method of payment.

In accordance with embodiments of the present invention, each device associated with a transaction session may maintain a list of products to be purchased. For example, the list may be a grocery list of items to be purchased by the group of shoppers. The list for each shopper may be updated as product identifiers are acquired by shoppers. For example, the list may be updated to indicate that a listed product has been acquired in response to one of the shoppers acquiring the corresponding product identifier.

In accordance with embodiments of the present invention, transactions for multiple shoppers may be combined into a single transaction session for conducting a purchase transaction. Product item identifiers collected by the shoppers may be combined in the single transaction session for purchase of the products in the purchase transaction. In addition, coupons or other purchase related information may be collected from the shoppers and combined in the single purchase transaction. The single purchase transaction may be conducted at a shopper terminal. The shopper terminal may use the purchase item identifiers, coupon information, or other purchase related information for conducting a single purchase transaction. For example, the shopper terminal may total the prices of the items being purchased, apply the collected coupons or other discount information, and any other purchase related information. For example, a discount may be applied if the purchase total is over a predetermined amount. In another example, a discount may be applied if the products for purchase meet predetermined criteria, such as, but not limited to, a total number of one or more types of product and the like. The products may be purchased by a shopper authorized to purchase the identified products. After the products are totaled and any discounts applied, a purchase transaction may be conducted at the shopper terminal or any other suitable interface via any suitable technique.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
associating, at at least a processor and memory, a user identifier of a first shopper with a transaction session for conducting a purchase transaction at a point-of-sale terminal;
receiving, at the at least a processor and memory, from a second shopper, a request to join the transaction session;
joining, at the at least a processor and memory, the second shopper with the transaction session based on the request; and
communicating, at the at least a processor and memory, information about the transaction session to the point-of-sale terminal for purchase of products in the purchase transaction by one of the first and second shoppers.

2. The method of claim 1, further comprising:
receiving customer card information that includes the user identifier of the first shopper; and
initializing the transaction session based on the customer card information.

3. The method of claim 2, wherein receiving the customer card information comprises receiving the customer card information via wireless communication.

4. The method of claim 1, further comprising:
receiving the user identifier of the first shopper and a password;
verifying the user identifier of the first shopper and the password; and
initializing the transaction session in response to verification of the user identifier of the first shopper and the password.

5. The method of claim 4, wherein receiving the user identifier of the first shopper and the password comprises receiving the user identifier of the first shopper and the password via wireless communication.

6. The method of claim 1, wherein receiving the request comprises receiving customer card information that includes the user identifier of the second shopper,
wherein the method further comprises verifying the user identifier of the second shopper, and
wherein joining the second shopper with the transaction session comprises joining the second shopper with the transaction session in response to verification of the user identifier of the second shopper and the password.

7. The method of claim 6, wherein receiving the customer card information comprises receiving the customer card information via wireless communication.

8. The method of claim 1, wherein receiving the request comprises receiving customer card information that includes the user identifier of the second shopper,
wherein the method further comprises failing to verify the user identifier of the second shopper and the password, and
wherein the method further comprises preventing joining of the second shopper with the transaction session in response to failing to verify the user identifier of the second shopper.

9. The method of claim 1, further comprising:
receiving the user identifier of the second shopper and a password; and
verifying the user identifier of the second shopper and the password, and
wherein joining the second shopper comprises joining the second shopper with the transaction session in response to verification of the user identifier of the second shopper and the password.

10. The method of claim 9, wherein receiving the user identifier of the second shopper and the password comprises receiving the user identifier of the second shopper and the password via wireless communication.

11. The method of claim 1, wherein receiving the request comprises receiving the user identifier of the second shopper and a password,
wherein the method further comprises failing to verify the user identifier of the second shopper and the password, and
further comprising preventing joining of the second shopper with the transaction session in response to failing to verify the user identifier of the second shopper and the password.

12. The method of claim 1, further comprising receiving product identifiers from mobile devices of the first and second shoppers, and
further comprising conducting the purchase transaction for products identified by the product identifiers.

13. (canceled)

14. The method of claim 12, further comprising receiving discount information from mobile devices of the first and second shoppers, and
wherein conducting the purchase transaction comprises applying the discount information for purchase of the products identified by the product identifiers.

15. A method comprising:
presenting, at at least a processor and memory, transaction session information of a first shopper;
receiving, at the at least a processor and memory, user input to join the transaction session as a second shopper; and
in response to receiving the user input, communicating, at the at least a processor and memory, to an electronic device a request to join the transaction session for purchase of products in a purchase transaction at a point-of-sale terminal by one of the first shopper and second shopper.

16. The method of claim 15, wherein presenting transaction session information of the first shopper comprises displaying the transaction session information.

17. The method of claim 15, further comprising communicating, to the electronic device, customer card information that includes an identifier of the first shopper in response to receiving the user input.

18. A method comprising:
managing, at at least a processor and memory, a transaction session of a first shopper;
receiving, at the at least a processor and memory, a request for allowing a second shopper to join the transaction session for purchase of products in a purchase transaction at a point-of-sale terminal by one of the first shopper and the second shopper;
receiving, at the at least a processor and memory, user input in response to the request; and
communicating, at the at least a processor and memory, the user input to an electronic device for responding to the request.

19. The method of claim 18, further comprising presenting the request.

20. The method of claim 19, wherein presenting the request comprises presenting a user identifier for the second shopper.

21. The method of claim 18, further comprising conducting the purchase transaction for products identified by the first and second shoppers.

22. An electronic device comprising:
a network interface configured to receive a request to join a transaction session from a first shopper; and
a transaction manager configured to:
associate a user identifier of a second shopper with the transaction session for conducting a purchase transaction at a point-of-sale terminal;
join the second shopper with the transaction session based on the request; and
communicate information about the transaction session to the point-of-sale terminal for purchase of products in the purchase transaction by one of the first and second shoppers.

23. The electronic device of claim 22, wherein the transaction manager is configured to:
receive customer card information that includes the user identifier of the second shopper; and
initialize the transaction session based on the customer card information.

24. The electronic device of claim 22, wherein the transaction manager is configured to:
receive the user identifier of the second shopper and a password;
verify the user identifier of the second shopper and the password; and
initialize the transaction session in response to verification of the user identifier of the second shopper and the password.

25. The electronic device of claim 22, wherein the network interface is configured to receive the user identifier of the first shopper and a password, and
wherein the transaction manager is configured to:
verify the user identifier of the first shopper and the password; and
process the transaction session comprises joining the first shopper with the transaction session in response to verification of the user identifier of the first shopper and the password.
